(19) United States
(12) Patent Application Publication
(10) Pub. No.: US 2014/0317381 A1
(43) Pub. Date: Oct. 23, 2014

(54) METHOD OF PROCESSING IMMEDIATE VALUE IN EISC PROCESSOR

(71) Applicants: Foundation for Research & Business, Seoul National University Of Science & Technology, (US); ADVANCED DIGITAL CHIPS INC., Gyeonggi-do (KR); KOREA UNIVERSITY RESEARCH AND BUSINESS FOUNDATION, Seoul (KR)

(72) Inventors: Seung Eun Lee, Seoul (KR); Yeong Seob Jeong, Gangwon-do (KR); Sang Don Kim, Gangwon-do (KR); Taeweon Suh, Seoul (KR); Han Yee Kim, Seoul (KR); Young Ho Cha, Gyeonggi-do (KR); Kwan Young Kim, Gyeonggi-do (KR)

(73) Assignees: Foundation for Research & Business, Seoul National University Of Science & Technology, Seoul (KR); Korea University Research and Business Foundation, Seoul (KR); Advanced Digital Chips Inc., Gyeonggi-do (KR)

(21) Appl. No.: 13/874,232

(22) Filed: Apr. 30, 2013

(30) Foreign Application Priority Data
Apr. 18, 2013 (KR) 10-2013-0042986

(51) Int. Cl. G06F 9/30

(52) U.S. Cl. CPC G06F 9/30112
USPC 712/200

(57) ABSTRACT

Disclosed is a method of operating an immediate value in an extendable instruction set computer (EISC) processor, comprising: checking whether or not an unsigned immediate value is used to generate an extension register (ER) value for operating an immediate value; and generating the ER value by performing zero extension for the unsigned immediate value using an unsigned load extension register with immediate (ULERI) instruction if the unsigned immediate value is used. It is possible to improve operational efficiency by preventing an LERI instruction from being unnecessarily executed when an immediate value is operated using a 16-bit instruction in the EISC processor.

### CROSS REFERENCES TO RELATED APPLICATIONS

The present invention contains subject matter related to Korean Patent Application No. 2013-042986, filed in the Korean Patent Office on Apr. 18, 2013, the entire contents of which are incorporated herein by reference.

### FIELD

The present invention relates to a 32-bit processor called an extendable instruction set computer (EISC) processor using a 16-bit instruction set, and more particularly, to a method of efficiently generating an extension register (ER) value for operating an immediate value in the EISC processor.

### BACKGROUND

A conventional complex instruction set computer (CISC) microprocessor is advantageous in code density. However, it is difficult to implement a high-speed CISC microprocessor. Meanwhile, a reduced instruction set computer (RISC) microprocessor generally has a 32-bit instruction set, which may disadvantageously cause an excessive increase of the program code length.

The EISC architecture has an instruction set designed to very effectively reduce an execution program size and memory access frequency. The EISC architecture is scalable such that various values such as an immediate value of the instruction and a bit composition can be freely extended using an extendable instruction set. The EISC has both advantages of conventional RISC and CISC architectures.

The EISC processor basically has a simple hardware structure similar to that of the RISC and additionally has advantages of the CISC to obtain excellent performance. Since code density is high, the EISC processor can make the program code more compact by approximately 60% compared to conventional RISC processors or by approximately 80% compared to conventional CISC processors. Therefore, the EISC is advantageously employed in the field of embedded application in which code density is important.

The EISC architecture is an instruction scalable computer architecture. That is, conventional processors have a limited length of the instruction operand, whereas the EISC processor includes an extension register (ER) and an extension flag (e_flag) so that the instruction operand length can be extended as long as the extension register size.

For example, if the instruction operand length is set to 16 bits, and the extension register size is set to 32 bits, the instruction operand can be extended up to 48 bits (=16+32 bits). Therefore, it is possible to simplify hardware, which is an advantage of the embedded processor. For such an instruction extension purpose, there is known a load extension register with immediate (LERI) instruction.

The LERI instruction sets an arbitrary value to the ER and asserts the extension flag e_flag. Then, in another instruction executed after the LERI instruction, it is checked whether or not the extension flag e_flag is asserted. If the extension flag e_flag is asserted, the ER value is added to the operand of that instruction to execute operation. In this way, the instruction operand is extended.

The LERI instruction has a 2-bit opcode and a 14-bit immediate value. In the LERI architecture, the immediate value is stored in the ER, and the value stored in the ER is extracted when extension of the immediate value is necessary afterwards. The extracted value is concatenated with the immediate value of the corresponding instruction. In this architecture, it is possible to effectively address problems that may be generated due to a short length of the immediate value. However, the code length may increase due to addition of the LERI, and this may degrade performance. For this reason, in the EISC processor, it is important to effectively process the LERI.

Since the EISC processor is a 32-bit processor, it can execute 32-bit immediate operation. Since the EISC processor uses a 16-bit instruction, a 4-bit immediate value may be included in the instruction for immediate operation. A separate method is necessary in order to use a longer bit length of the immediate value. Therefore, in a case where a longer bit length of the immediate value is necessary in conventional EISC processors, the ER value is generated based on the LERI instruction before the immediate operation is processed. In addition, the ER value generated in advance is used in the immediate operation.

The ER generates a 14-bit immediate value of the LERI instruction through sign extension. However, in such a conventional method, the ER is unconditionally subjected to the sign extension even when an unsigned immediate value is employed. This may necessitate an additional instruction code and reduce code density accordingly.

### SUMMARY

This section provides a general summary of the disclosure, and is not a comprehensive disclosure of its full scope or all of its features. In view of the aforementioned problems, the present invention provides a method of operating an immediate value capable of improving operational efficiency by preventing an LERI instruction from being unnecessarily executed when an EISC processor operates an immediate value.

According to an aspect of the invention, there is provided a method of operating an immediate value in an extendable instruction set computer (EISC) processor, including: checking whether or not an unsigned immediate value is used to generate an extension register (ER) value for operating an immediate value; and generating the ER value by performing zero extension for the unsigned immediate value using an unsigned load extension register with immediate (ULERI) instruction if the unsigned immediate value is used.

The method may further include generating the ER value by performing sign extension for the immediate value using a load extension register with immediate (LERI) instruction in a case where a signed immediate value is used to generate the ER value for operating the immediate value.

The EISC processor may be a 32-bit processor operating a 32-bit immediate value, and each length of both the ULERI instruction and the LERI instruction may be set to 16 bits.

According to the present invention, it is possible to improve operational efficiency by preventing the LERI instruction from being unnecessarily executed when the immediate value is operated using a 16-bit instruction in the EISC processor. In particular, this invention is efficiently applied to a field in which unsigned values are mainly operated, such as signal processing. In addition, it is possible to increase code density to improve operational efficiency of the processor.

### BRIEF DESCRIPTION OF THE DRAWINGS

The foregoing and additional features and characteristics of this disclosure will become more apparent from the following detailed description considered with reference to the accompanying drawings, wherein:

FIG. 1 is a diagram illustrating a process of generating an ER value using an LERI instruction;

FIG. 2 is a diagram illustrating a process of generating an ER value using a plurality of LERI instructions;

FIG. 3 is a diagram illustrating a process of generating an unsigned immediate value using an LERI instruction;

FIG. 4 is a diagram illustrating a process of generating an unsigned immediate value using an ULERI instruction; and

FIG. 5 is a flowchart illustrating a method of operating an immediate value in an EISC processor according to an embodiment of the invention.

### DETAILED DESCRIPTION

Hereinafter, embodiments of the invention will be described in detail with reference to the accompanying drawings. It is noted that like reference numerals denote like elements throughout overall drawings. In addition, descriptions of well-known apparatus and methods may be omitted so as to not obscure the description of the representative embodiments, and such methods and apparatus are clearly within the scope and spirit of the present disclosure. The terminology used herein is only for the purpose of describing particular embodiments and is not intended to limit the invention. As used herein, the singular forms “a”, “an,” and “the” may be intended to include the plural forms as well, unless the context clearly indicates otherwise. It is further to be noted that, as used herein, the terms “comprises”, “comprising”, “include”, and “including” indicate the presence of stated features, integers, steps, operations, units, and/or components, but do not preclude the presence or addition of one or more other features, integers, steps, operations, units, and/or components, and/or combination thereof.

The present invention proposes a method of operating an immediate value in an extendable instruction set computer (EISC) processor.

In the method of operating an immediate value according to the present invention, there is proposed a method of efficiently operating an immediate value by concatenating a conventional load extension register with immediate (LERI) instruction and an additional unsigned load extension register with immediate (ULERI) instruction.

FIG. 1 is a diagram illustrating a process for generating an extension register (ER) value using a load extension register with immediate (LERI) instruction.

Referring to FIG. 1, the EISC processor generates the ER value by extending a 14-bit immediate value of the LERI instruction to 32 bits (sign extension).

In this case, a value obtainable using a single LERI instruction is limited to 14 bits. A plurality of LERI instructions are necessary in order to generate a longer bit length of the immediate value.

For example, if a signed variable 0x21FF (hexadecimal number) is extended to 32 bits, it is necessary to perform sign extension to store 0xFFFFE1FF in the ER. As illustrated in FIG. 1, this operation may be processed using the LERI instruction.

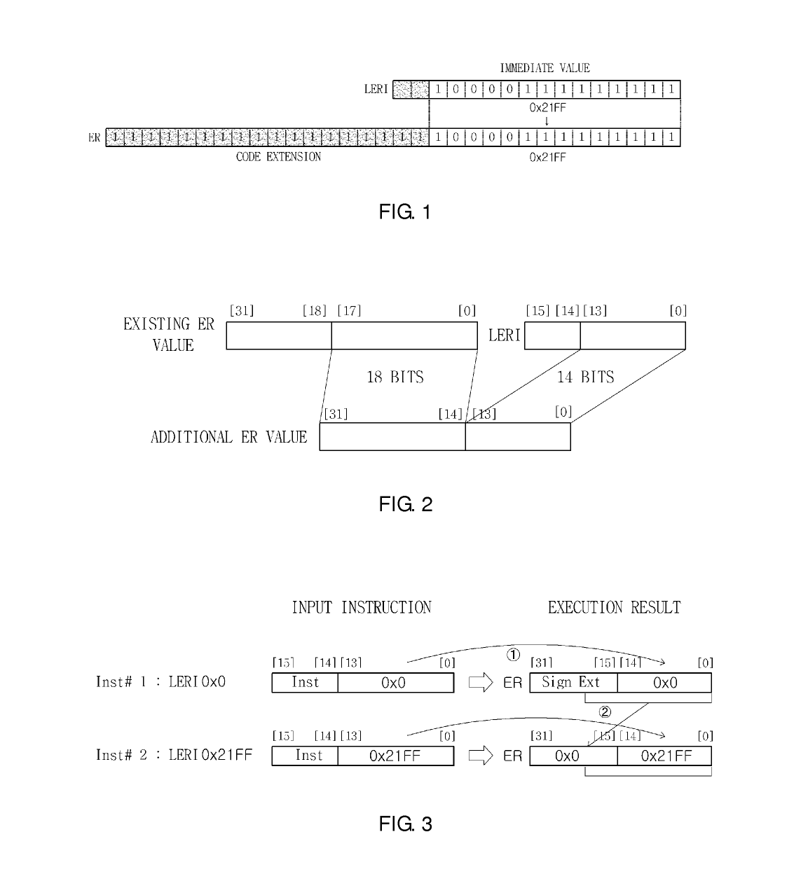

FIG. 2 is a diagram illustrating a process of generating an ER register value using a plurality of LERI instructions.

Referring to FIG. 2, the EISC processor generates the ER value using a plurality of LERI instructions. That is, it is possible to generate a longer bit length of the immediate value using the existing ER value generated through sign extension and an additional immediate value of the LERI instruction. In this manner, it is possible to generate the immediate value up to 32 bits at maximum.

FIG. 2 illustrates a process of generating a 32-bit ER value by copying 14 bits of the LERI instruction and copying 18 bits of the existing ER value.

FIG. 2 illustrates a process of generating an unsigned immediate value using the LERI instruction.

FIG. 3 illustrates a process of extending an unsigned variable 0x21FF (hexadecimal number) to 32 bits, in which 0x000021FF is stored in the ER register. In this case, the LERI instruction is used in the processing.

Referring to FIG. 3, in the process of generating the unsigned hexadecimal immediate value using two LERI instructions, the LERI instruction is first processed. In this process, the 32-bit data value 0x00000000 is created in the ER (\textcircled{1})

Then, using the existing ER value and the immediate value 0x21FF of the LERI instruction, a value 0x000021FF is created (\textcircled{2})

In this manner, in a case where an unsigned immediate value is generated using the LERI instruction in the EISC processor, two LERI instructions are necessary.

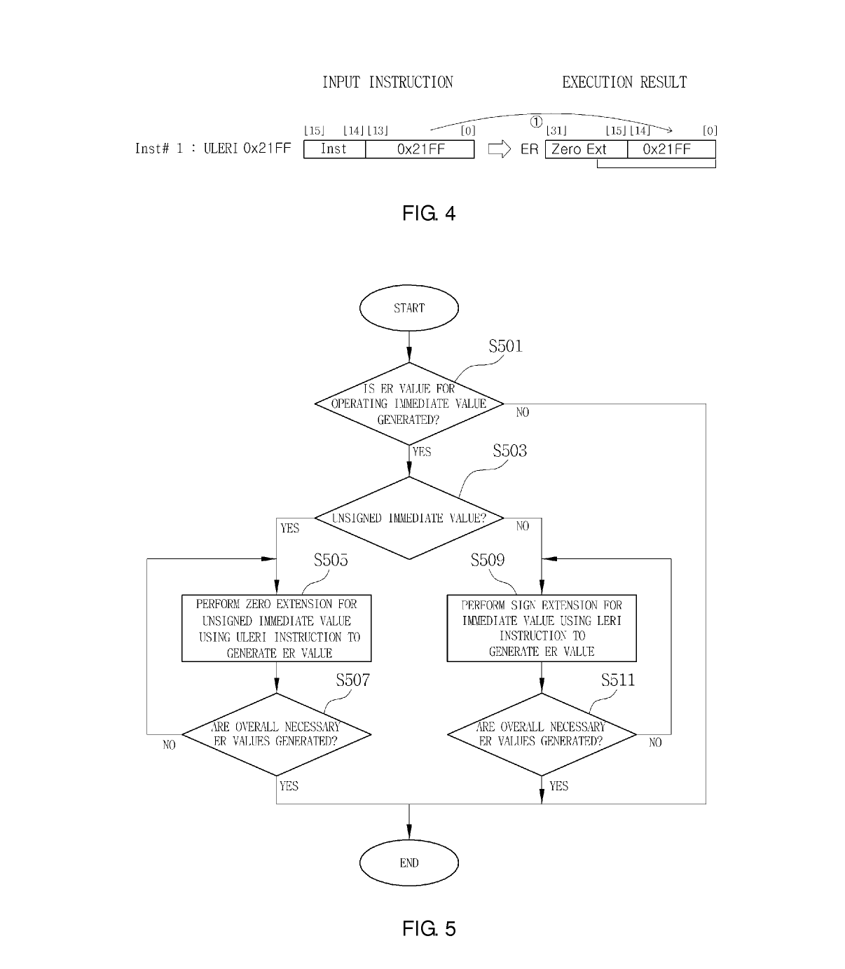

FIG. 4 is a diagram illustrating a process of generating an unsigned immediate value using an unsigned load extension register with immediate (ULERI) instruction.

Referring to FIG. 4, the EISC processor generates an unsigned immediate value using the ULERI instruction. That is, the EISC processor generates the ER value based on a zero extension method using the ULERI instruction. In FIG. 4, through zero extension, 32-bit data 0x000021FF is created.

FIG. 5 is a flowchart illustrating a method of operating the immediate value using the EISC processor according to an embodiment of the invention.

Referring to FIG. 5, in the method of operating the immediate value in the EISC processor, the EISC processor checks whether or not it is necessary to generate the ER value for operating the immediate value (S501).

If it is necessary to generate the ER value for operating the immediate value, it is checked whether or not an unsigned immediate value is used (S503).

If an unsigned immediate value is used, the ER value is generated by performing zero extension for the unsigned immediate value using the ULERI instruction (S505).

Then, it is checked whether or not overall necessary ER values are generated (S507). The ER value is continuously generated until the overall necessary ER values are generated. If the overall necessary ER values are generated, this process is terminated.

In a case where a signed immediate value is used to generate the ER value for operating the immediate value in the present invention, the ER value is generated by performing sign extension for the immediate value using an LERI instruction (S509).

Then, it is checked whether or not overall necessary ER values are generated (S511). The ER value is continuously generated until the overall necessary ER values are generated. If the overall necessary ER values are generated, this process is terminated.

In the present invention, the EISC processor is a 32-bit processor operating a 32-bit immediate value, and each length of both the ULERI instruction and the LERI instruction is set to 16 bits.

Although exemplary embodiments of the present invention have been shown and described, it will be apparent to those having ordinary skill in the art that a number of changes, modifications, or alterations to the invention as described herein may be made, none of which depart from the spirit of the present invention.

All such changes, modifications and alterations should therefore be seen as within the scope of the present invention.

What is claimed is:

1. A method of operating an immediate value in an extendable instruction set computer (EISC) processor, comprising:
checking whether or not an unsigned immediate value is used to generate an extension register (ER) value for operating an immediate value; and
generating the ER value by performing zero extension for the unsigned immediate value using an unsigned load extension register with immediate (ULERI) instruction if the unsigned immediate value is used.

2. The method of claim 1, further comprising generating the ER value by performing sign extension for the immediate value using a load extension register with immediate (LERI) instruction in a case where a signed immediate value is used to generate the ER value for operating the immediate value.

3. The method of claim 2, wherein the EISC processor is a 32-bit processor operating a 32-bit immediate value, and
each length of both the ULERI instruction and the LERI instruction is set to 16 bits.
